(19) United States
(12) Patent Application Publication
(10) Pub. No.: US 2023/0232879 A1
(43) Pub. Date: Jul. 27, 2023

(54) PROCESS FOR OBTAINING A FRUIT SAUCE AND SAUCE THEREBY OBTAINED

(71) Applicants: Aitor MARTINEZ MUR, Zaragoza (ES); Emma LORENTE DE LA RIVA, Pinseque (ES)

(72) Inventor: Aitor MARTINEZ MUR, Zaragoza (ES)

(21) Appl. No.: 18/157,839

(22) Filed: Jan. 22, 2023

(30) Foreign Application Priority Data
Jan. 26, 2022 (ES) P 202230057

(51) Int. Cl. A23L 27/60; A23L 19/00

(52) U.S. Cl. CPC A23L 27/60; A23L 19/09

(57) ABSTRACT

The invention provides a process for obtaining a mayonnaise-type fruit sauce wherein the fruit is first conditioned and the aqueous phase of the sauce is prepared by heating to boiling together with mint leaves, white or apple vinegar, and fruit juice, then decreasing the heating temperature and maintaining it until a thick mixture is obtained, which is crushed, sieved, and allowed to stand at room temperature for 10-12 hours, and subsequently the already conditioned fruit is emulsified in an oily phase with pasteurised egg yolk and sunflower oil.

### FIELD OF THE INVENTION

The present invention relates to a method for obtaining a fruit sauce, more specifically a mayonnaise type fruit sauce, as well as to the sauce obtained by such a process.

### BACKGROUND

Mayonnaise sauce is well known around the world, and is a cold emulsified sauce made essentially from whole egg and vegetable oil blended together. These mayonnaise-type sauces can be flavoured with numerous seasonings, such as garlic, spices or natural or synthetic flavourings, simply by adding said ingredients to the sauce either during its emulsification or once emulsified.

The main problem of this type of sauces is the separation of the aqueous phase and the oily phase, such that a stable emulsion is not obtained. This problem is greater when the seasoning has a high water content, as is the case of natural fruits.

Thus, for example, ES2140903 describes the use of a vegetable or fruit puree as a vegetable protein base for the preparation of an emulsified sauce where, to increase the emulsifying capacity of the vegetable protein, an emulsion stabilizer, such as a commercial whey protein, and an electrolyte, such as potassium sorbate, are added and the emulsion is homogenized at temperatures of 10 to 55° C. under high shear and high pressure conditions.

### SUMMARY

The present invention provides a method for obtaining a mayonnaise-type fruit sauce, comprising a first stage of conditioning of the fruit and preparation of an aqueous phase of the sauce where the fruit, washed and where appropriate peeled, is heated to boiling together with mint leaves, white or apple vinegar and juice of the same fruit, in the following proportions: 60-65% by weight of fruit, 2-2.5% by weight of mint leaves, 2-2.5% by weight of white or apple vinegar and 30-36% by weight of fruit juice, then decreasing the heating temperature and maintaining it until a thick mixture is obtained, which is crushed, sieved and left to stand at room temperature for 10-12 hours and a second emulsion step of the fruit already conditioned in an oil phase where, to the crushed and filtered mixture obtained in the previous conditioning step, pasteurised egg yolk is added in a volume ratio of conditioned mixture:pasteurised egg yolk of 2.5:1 and, gradually, while blending, sunflower oil is added until complete emulsion. Furthermore, the invention provides a mayonnaise-type fruit sauce obtained according to the method for use as a food dressing.

### DETAILED DESCRIPTION

The sauce obtained from the application of the method of the invention, which can be made with any type of fresh fruit, allows obtaining a mayonnaise-type sauce with incorporated fruit, applicable for dressing or accompanying all types of meats, salads, fish, vegetables or desserts. Thus, in addition to having the organoleptic characteristics derived from the fruit emulsified with a vegetable oil, the sauce obtained has a greater nutritional value thanks to the contribution of fibre and vitamins of the fruits, while maintaining the soft and creamy texture of a traditional mayonnaise.

The present invention solves the problems of emulsion and stabilization of these mayonnaise-type fruit sauces without the need to add stabilizers or electrolytes or complex adaptation processes.

To this end, the method of the invention for obtaining a mayonnaise-type fruit sauce consists of two steps, a first step of conditioning the fruit and a second step of emulsifying the conditioned fruit.

It should be noted that this method, in particular its first stage, can be carried out with any type of fruit regardless of its water content, acidity or fibre content, choosing the fruit or the combination of fruits according to the final flavour desired for the mayonnaise-type sauce.

Thus, once the fruit has been selected, it is washed and, where appropriate, peeled before the conditioning step.

The fruit conditioning stage is where the aqueous phase of the mayonnaise-type sauce is prepared, and consists of heating to boiling a mixture of the desired fruit, mint leaves, white or apple vinegar and juice of the same fruit, in the following proportions: 60-65% by weight of fruit, 2-2.5% by weight of mint leaves, 2-2.5% by weight of white or apple vinegar and 30-36% by weight of fruit juice, and then lowering the heating temperature and maintaining it until a thick mixture is obtained, which is crushed and sieved and then allowed to stand at room temperature for 10-12 hours.

In the second stage, of emulsion in an oily phase to obtain a mayonnaise-type sauce, pasteurised egg yolk is added to the crushed and filtered mixture obtained in the previous conditioning step, in a volume ratio of conditioned mixture:pasteurised egg yolk of 2.5:1 and, gradually, while blending, sunflower oil is added until complete emulsion. In one embodiment of the invention, the ratio of conditioned mixture:pasteurised egg yolk:sunflower oil is 2.5:1:1.5 by volume.

In one embodiment, before adding the sunflower oil, natural preservatives such as pepper, ginger, mustard powder, cardamom, salt, or any combination of two or more thereof, are added to the pasteurised egg yolk mixture and the conditioned fruit. If present, these preservatives are added in a total amount of between 60.00 and 65.00 grams per litre of mayonnaise-type fruit sauce.

Likewise, in another embodiment, to the mixture of pasteurised egg yolk and conditioned fruit and, where appropriate, natural preservatives, a natural flavour of the fruit chosen in the conditioning stage is added, in an amount of 30.00 and 40.00 grams per litre of mayonnaise type fruit sauce.

### Examples

Preparation of a Mayonnaise-Type Orange Sauce

Peel oranges to obtain 500 g of peeled oranges and place in a container together with 20 g of mint leaves, 20 ml of white or apple vinegar and 250 ml of natural orange juice, and heat the container until the mixture boils. Then lower the heating temperature until a thick mixture is obtained, at this point removing the container from the heat, and crush and pass the mixture through a sieve. Allow to stand for 12 hours at room temperature.

To 500 ml of the above mixture of conditioned oranges, add 200 ml of pasteurised egg yolk, 70 g of a mixture of pepper, ginger, mustard powder, cardamom and salt, or other desired natural preservative, 30 g of natural orange flavouring powder and, gradually, while blending said mixture, add 300 ml of sunflower oil.

As a result, an emulsified mayonnaise type sauce with a stable orange flavour is obtained, where no separation of the aqueous and oily phases can be seen, with a creamy texture and a soft orange colour.

What is claimed is:

1. A method for obtaining a mayonnaise-type fruit sauce, comprising:
i) a first stage of conditioning of the fruit and preparation of an aqueous phase of the sauce where the fruit, washed and where appropriate peeled, is heated to boiling together with mint leaves, white or apple vinegar and juice of the same fruit, in the following proportions: 60-65% by weight of fruit, 2-2.5% by weight of mint leaves, 2-2.5% by weight of white or apple vinegar and 30-36% by weight of fruit juice, then decreasing the heating temperature and maintaining it until a thick mixture is obtained, which is crushed, sieved and left to stand at room temperature for 10-12 hours and
ii) a second emulsion step of the fruit already conditioned in an oil phase where, to the crushed and filtered mixture obtained in the previous conditioning step, pasteurised egg yolk is added in a volume ratio of conditioned mixture:pasteurised egg yolk of 2.5:1 and, gradually, while blending, sunflower oil is added until complete emulsion.

2. The method for obtaining a mayonnaise-type fruit sauce according to claim 1, wherein the ratio of conditioned mixture:pasteurised egg yolk:sunflower oil in step ii) is 2.5:1:1.5 by volume.

3. The method for obtaining a mayonnaise-type fruit sauce according to claim 1, wherein before adding the sunflower oil in step ii), natural preservatives are added.

4. The method for obtaining a mayonnaise-type fruit sauce according to claim 3, wherein the natural preservatives are selected from the group consisting of pepper, ginger, mustard powder, cardamom, salt or any combination of two or more thereof.

5. The method for obtaining a mayonnaise-type fruit sauce according to claim 3, wherein the natural preservatives are added in a total amount of between 60.00 and 65.00 grams per litre of mayonnaise-type fruit sauce.

6. The method for obtaining a mayonnaise-type fruit sauce according to claim 1, wherein step ii), a natural flavouring of the fruit chosen in the conditioning step is added, in an amount of 30.00 and 40.00 grams per litre of mayonnaise-type fruit sauce.

7. A mayonnaise-type fruit sauce obtained according to the method of claim 1 for use as a food dressing.
